(19) United States
(12) Patent Application Publication
(10) Pub. No.: US 2006/0237597 A1
(43) Pub. Date: Oct. 26, 2006

(54) Removably mountable intravenous tubing holder

(76) Inventor: Maureen D'Andria, Ft. Lauderdale, FL (US)

Correspondence Address: Oltman, Flynn & Kubler;Suite #415, 915 Middle River Drive, Fort Lauderdale, FL, 33304, US

(21) Appl. No.: 11/059,697

(22) Filed: Feb. 17, 2005

(51) Int. Cl. F16L 3/00

(52) U.S. Cl. 248/68.1; 248/51

(57) ABSTRACT

A tube holding apparatus includes a mounting block having a block fastening end with a block fastening structure for removably securing the mounting block to a support surface and having a tube engaging end with several tube retaining structures. The block fastening structure includes a first fastener section of hook and loop fastener material secured to the block fastening end and a second fastener section of hook and loop material for mounting to a support surface to which the apparatus is to be secured, so that the mounting block can be removably secured to a support surface. The mounting block is configured as a panel and formed of resilient material and each tube retaining structure includes a tube receiving slot having substantially parallel slot sides extending into the mounting block and a slot width narrower than the diameter of a tube to be retained by the apparatus.

### BACKGROUND OF THE INVENTION

1. Field of the Invention

The present invention relates generally to the field of devices for administering medication. More specifically the present invention relates to a tube holding apparatus including a mounting block having a block fastening end with fastening means for removably securing the mounting block to a support surface near a patient such as a patient bed, and having a tube engaging end with at least one and preferably several tube retaining structures. Securing the mounting block to a support surface removably is important because it permits the mounting block and one or more tubes to be detached and moved as an organized unit together with the patient, especially in the event of an emergency.

The fastening means include a first fastener section of hook and loop fastener material secured to the block fastening end and a second fastener section of hook and loop material mounted to a support surface near a patient to which the apparatus is to be secured, so that the mounting block can be removably secured to the support surface. The apparatus preferably is provided with the first and second fastener sections fitted engagingly together and with a layer of adhesive on the rearward face of the second fastener section for bonding the second fastener section to the surface. The adhesive is covered with a removable cover sheet which is manually pealed away to mount the apparatus. Alternatively, a suitable adhesive is provided on the block fastening end permitting the mounting block to be secured to the surface removably.

The mounting block preferably is formed of resilient material and each tube retaining structure preferably includes a tube receiving slot leading into the mounting block, so that a tube can be manually pressed against the slot outer end, resiliently spreading the slot open, and laterally passing the tube into the tube receiving slot. The walls of the tube receiving slot resiliently bear against and engage the tube to retain the tube in the holder. The mounting block preferably is configured as a thin panel, and the block fastening end and tube engaging end are opposing narrow longitudinal faces of the panel.

2. Description of the Prior Art

There have long been holders or harnesses for engaging one or more cords or tubes to hold the cords or tubes in desired relative spaced positions. Such holders have taken the form of blocks and plates with arrays of cord and tube retaining slots and ports. Such structures are illustrated in Pyeatt, et al., U.S. Pat. No. Des. 378,408 issued on Mar. 11, 1997 for a cord and tube holder; Macko, U.S. Pat. No. Des. 379,509 issued on May 27, 1997 for a multiple I.V. holder; Saotome, et al., U.S. Pat. No. 4,705,244 issued on Nov. 10, 1987 for a tube protecting device with a spring mounting structure secured with a screw at one end to a support surface; London, U.S. Pat. No. 4,988,062 issued on Jan. 29, 1991 for an apparatus, system and method for organizing and maintaining several medical catheters; Garrett, et al., U.S. Pat. No. 5,427,338 issued on Jun. 27, 1995 for an intravenous and transducer line organizer; and Yokoyama, et al., U.S. Pat. No. 5,876,371 issued on Mar. 2, 1999 for an intravenous tube holder.

LaHay, U.S. Pat. No. 3,696,920 issued on Oct. 10, 1972 discloses a device for organizing objects including a block of semi-rigid foam containing one or more object retaining channels and a beveled slot opening into each channel for passing an object into each channel and means for adhesively securing the block outer surface to a suitable supporting surface.

Sularz, U.S. Pat. No. 4,971,271, issued on Nov. 20, 1990 teaches an article organizer and holder assembly including a main support base, an article receiver and retainer assembly mounted on the support base, and a connector means having a pair of clip members each attached to respective outer ends of the main support base for attachment to a medical patient bed sheet or similar structure. A problem with these prior retaining devices when used to retain medical tubes has been that when the patient must be moved quickly, critical time is lost because of the need to either remove each individual tube from the device, and that after removal the tubes can become tangled and bent around each other to obstruct fluid flow because they are no longer being held in their spaced relationship.

It is thus an object of the present invention to provide a medical fluid administering tube holding apparatus which can be quickly removed from a support surface together with the retained tubes when necessary, such as when moving the patient, and thereby moved with the patient.

It is another object of the present invention to provide such a tube holding apparatus which retains the tubes it is holding in their untangled spaced relationship after disconnection from the support surface.

It is still another object of the present invention to provide such a tube holding apparatus which is easy to use and reliable.

It is finally an object of the present invention to provide such a tube holding apparatus which simple in design and highly inexpensive to manufacture.

### SUMMARY OF THE INVENTION

The present invention accomplishes the above-stated objectives, as well as others, as may be determined by a fair reading and interpretation of the entire specification.

A tube holding apparatus is provided, including a mounting block having a block fastening end with a block fastening structure for removably securing the mounting block to a support surface and having a tube engaging end with at least one tube retaining structure.

The tube engaging end preferably includes several tube retaining structures. The block fastening structure preferably includes a first fastener section of hook and loop fastener material secured to the block fastening end and a second fastener section of hook and loop material for mounting to a support surface to which the apparatus is to be secured, so that the mounting block can be removably secured to a support surface. The second fastener section preferably has a second fastener section rearward face, additionally including a layer of adhesive on the second fastener section rearward face for bonding the second fastener section to a support surface. The adhesive preferably is covered with a removable cover sheet which is manually pealed away to mount the apparatus.

The mounting block preferably is formed of resilient material and the tube retaining structure preferably includes a tube retaining slot extending into the mounting block, so that a tube can be manually pressed against the slot outer end, resiliently spreading the slot open and passing the tube fully into the slot. The mounting block preferably is configured as a panel, and the block fastening end and the tube engaging end preferably are opposing longitudinal faces of the panel.

A tube holding apparatus is further provided, including a tube to be retained having a tube diameter; a mounting block having a block fastening end with a block fastening structure for securing the mounting block to a support surface and having a tube engaging end with at least one tube retaining structure; the mounting block including resilient material and the tube retaining structure comprises a tube receiving slot narrower in width than the tube diameter and having substantially parallel slot sides extending into the resilient material; so that the tube can be mounted in the tube receiving slot by manually pressing the tube against the slot outer end, resiliently spreading the slot open to laterally enter the tube receiving slot so that the slot sides resiliently bear against and retain the tube.

The tube engaging end preferably includes several tube retaining structures. The mounting block preferably is configured as a panel, and the block fastening end and the tube engaging end preferably are opposing longitudinal faces of the panel.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of the apparatus secured to a support surface with a tube fitted into one of the tube retaining structures.

FIG. 2 is a broken away close-up view of the block rearward end, showing the first and second fastener sections, the layer of adhesive on the second fastener section rearward face and the cover sheet partially pealed away from the second fastener section rearward face to reveal the layer of adhesive.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

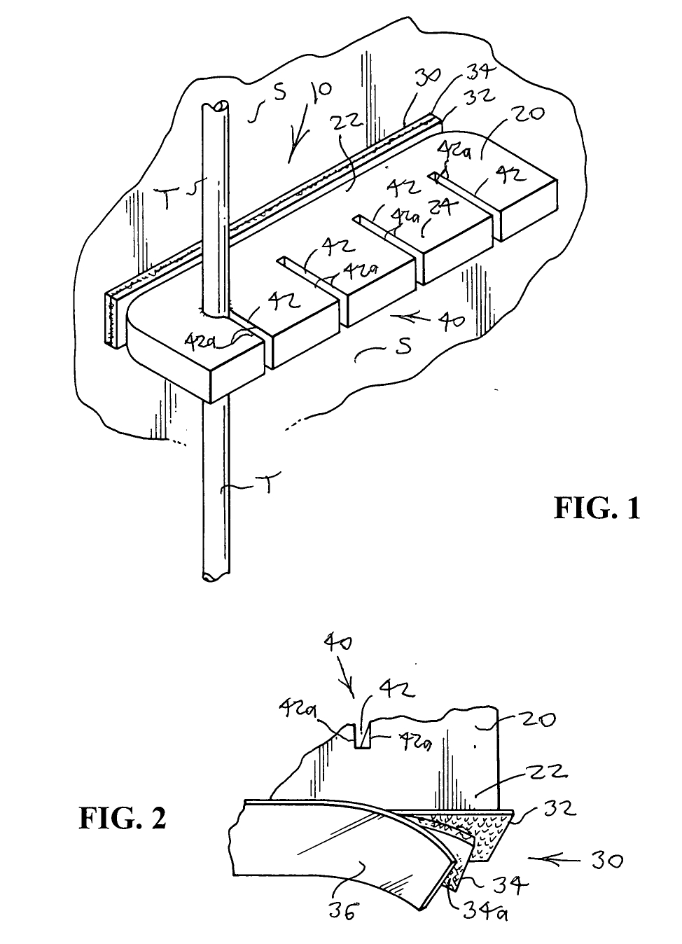

Referring to FIGS. 1-2, a tube holding apparatus 10 is disclosed including a mounting block 20 having a block fastening end 22 with fastening means 30 for removably securing the mounting block 20 to a support surface S near a patient such as a patient bed, and having a tube engaging end 24 with at least one and preferably several tube retaining structures 40. Securing the mounting block 20 to a support surface S removably is important because it permits the mounting block 20 and one or more tubes T to be detached and moved as an organized unit along with the patient, especially in the event of an emergency.

The fastening means 30 preferably includes a first fastener section 32 of hook and loop fastener material secured to the block fastening end 22 and a second fastener section 34 of hook and loop material mounted to a support surface S near a patient to which the apparatus 10 is to be secured, so that the mounting block 20 can be removably secured to the support surface S. The apparatus 10 preferably is provided with the first and second fastener sections 32 and 34 fitted engagingly together and with a layer of adhesive 34a on the rearward face of the second fastener section 34 for bonding the second fastener section 34 to the surface S. The adhesive 34a is covered with a removable cover sheet 36 which is manually pealed away to mount the apparatus 10. Alternatively, a suitable releasible adhesive 38 is provided on the block fastening end permitting the mounting block to be secured to the surface removably.

The mounting block 20 preferably is formed of resilient material and each tube retaining structure 40 preferably includes a tube receiving slot 42 narrower in slot width than the diameter of a tube T to be retained by apparatus 10 so that the slot sides 42a can resiliently grip the tube T and having substantially parallel slot sides 42a extending the entire slot 42 length into the mounting block 20, so that a tube can be manually pressed against the slot 42 open outer end, resiliently spreading the slot 42 open, and laterally passing the tube T into the tube receiving slot 42. The parallel walls of the tube receiving slot 42 resiliently bear against and engage the tube T to retain the tube T in the holder apparatus 10. The mounting block 20 preferably is configured as a thin panel as shown in FIG. 1, and the block fastening end 22 and tube engaging end 24 are opposing narrow longitudinal faces of the panel 20.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A tube holding apparatus, comprising:
a mounting block having a block fastening end with block fastening means for removably securing said mounting block to a support surface and having a tube engaging end with at least one tube retaining structure.

2. The apparatus of claim 1, wherein said tube engaging end comprises a plurality of tube retaining structures.

3. The apparatus of claim 1, wherein said block fastening means comprise a first fastener section of hook and loop fastener material secured to said block fastening end and a second fastener section of hook and loop material for mounting to a support surface to which the apparatus is to be secured;
such that said mounting block can be removably secured to a support surface.

4. The apparatus of claim 3, wherein said second fastener section has a second fastener section rearward face, additionally comprising a layer of adhesive on said second fastener section rearward face for bonding said second fastener section to a support surface.

5. The apparatus of claim 4, wherein said adhesive is covered with a removable cover sheet which is manually pealed away to mount said apparatus.

6. The apparatus of claim 1, wherein said mounting block is formed of resilient material and said tube retaining structure comprises a tube receiving slot extending into the mounting block;
such that a tube can be manually pressed against said slot outer end, resiliently spreading the slot open to laterally enter said tube receiving slot.

7. The apparatus of claim 6, wherein said mounting block is configured as a panel, and wherein said block fastening end and said tube engaging end are opposing longitudinal faces of said panel.

8. A tube holding apparatus, comprising:
a tube to be retained having a tube diameter;
a mounting block having a block fastening end with block fastening means for securing said mounting block to a support surface and having a tube engaging end with at least one tube retaining structure; said mounting block comprising resilient material and said tube retaining structure comprises a tube receiving slot narrower in width than the tube diameter and having substantially parallel slot sides extending into the resilient material;
such that said tube can be mounted in said tube receiving slot by manually pressing said tube against said slot outer end, resiliently spreading said slot open to laterally enter said tube receiving slot so that the slot sides resiliently bear against and retain said tube.

9. The apparatus of claim 8, wherein said tube engaging end comprises a plurality of tube retaining structures.

10. The apparatus of claim 8, wherein said mounting block is configured as a panel, and wherein said block fastening end and said tube engaging end are opposing longitudinal faces of said panel.
